(19) United States
(12) Patent Application Publication
(10) Pub. No.: US 2010/0063944 A1
(43) Pub. Date: Mar. 11, 2010

(54) SYSTEM AND METHOD FOR INTEGRATED HEALTH PROMOTION, INJURY PREVENTION AND MANAGEMENT

(76) Inventors: Troy Grogan, Wamberal (AU); David Harris, Seattle, WA (US); Chris Peres, Forresters Beach (AU)

Correspondence Address: BLACK LOWE & GRAHAM, PLLC, 701 FIFTH AVENUE, SUITE 4800, SEATTLE, WA, 98104, US

(21) Appl. No.: 12/541,799

(22) Filed: Aug. 14, 2009

Related U.S. Application Data
(63) Continuation of application No. 11/317,883, filed on Dec. 22, 2005, now abandoned.
(60) Provisional application No. 60/638,506, filed on Dec. 22, 2004.
(60) Provisional application No. 60/639,232, filed on Dec. 23, 2004.

(51) Int. Cl. G06Q 90/00

(52) U.S. Cl. 705/500

(57) ABSTRACT

One embodiment includes a system and method to integrate a participant's medical, physical, behavioral and psychological risk factors, historical morbidity and injury profile and the resultant health-care costs allowing for specifically targeted strategies to be developed for highly effective individual and corporate/organizational health promotion.

### PRIORITY CLAIM

This application is a continuation of U.S. application Ser. No. 11/317,883 filed Dec. 22, 2005 which claims the benefit of U.S. Provisional Application No. 60/638,506 filed on Dec. 22, 2004 and of U.S. Provisional Application No. 60/639,232 filed on Dec. 23, 2004; all of which are hereby incorporated by reference in their entirety.

### BACKGROUND OF THE INVENTION

Insurance premiums for employer sponsored health benefits reached $520 billion in 2004. These numbers cannot be sustained in the current marketplace. Legacy benefit costs are retarding growth, distorting wages, and killing profitability in entire business sectors.

In one embodiment, this problem is solved by offering an industry specific, systems based, and/or integrated system and method for integrated health promotion, injury prevention, and/or management,

### SUMMARY OF THE INVENTION

A method for integrated health promotion, injury prevention, and management. The method includes, integrating users risk information and assessing health needs of a participant. Using this risk assessment, a code of fitness is assigned to a participant. Finally a fitness action plan is developed for the participant.

### BRIEF DESCRIPTION OF THE DRAWINGS

Preferred and alternative embodiments of the present invention are described in detail below with reference to the following drawings.

FIG. 1 shows a method of using a health, fitness, and wellness program;

FIG. 2 shows the integration of the main themes of one embodiment;

FIG. 3 shows a method of producing organizational level change;

FIG. 4 shows a method of using a database;

FIG. 5 is a table representing the AlphaOne Code of Fitness in one embodiment;

FIG. 6-18 are surveys used to determine a participants AlphaOne Code of Fitness in one embodiment;

FIG. 19-24 are tables representing distinct method steps of one embodiment;

FIGS. 25-33 show Q scale guidelines in one embodiment; and

FIGS. 34-36 shows screenshots of assessing the AlphaOne Code of Fitness in one embodiment.

### DETAILED DESCRIPTION OF THE PREFERRED EMBODIMENT

The preferred embodiment is a system and method that integrates a participant's medical, physical, behavioral and psychological risk factors, historical morbidity and injury profile and the resultant health-care costs allowing for specifically targeted strategies to be developed for highly effective individual and corporate/organizational health promotion.

In one embodiment, the system and method uses an actual participant's health and fitness assessment data, occupational health and safety, and/or healthcare data. Then utilizes workplace systems and communication, web-based and personal (one to one) intervention strategies to lower the individuals' health risk factors. Therefore, the organizations health risk factors are lowered resulting in a boost of human performance and workplace productivity.

The system and method of one embodiment combines the previously separate areas of wellness, safety, and disability/injury management to increase efficiency and improve health, safety, and productivity outcomes in all areas. The Code of Fitness is used to tailor personal and organizational health strategies to suit specific industry groups.

A health, fitness, and wellness program needs to reflect the organizational culture to attract and have meaning for users at greatest risk. Evidence from international research shows that health initiatives are more effective when tailored to suit the industry towards which they are directed. In other words, an evidence based approach to promoting health at work requires that the program be tailored to suit the industry group for whom the program is intended. The rewards of adopting a more integrated approach to managing workforce health go beyond harm minimization, and contribute to an organization's efforts to foster a supportive culture where responsibility for managing health and safety is shared between management and workers. It is also the most likely method by which organizations will achieve and sustain the target of zero injuries. There is growing evidence that an integrated approach to preventing injury, promoting health, and managing injury produces better results in all areas more so than a singular approach. For example, research shows that employees are more likely to participate in health programs when personal and occupational risk factors are linked. Furthermore changes to occupational health safety, workers compensation, and injury management legislation emphasize the need for more attention to prevention.

In one embodiment, each health, fitness, and wellness program is tailored on the basis of detailed university-level research to address the legislative, business and cultural drivers that organizations are responding to. In this way, the system and method assists organizations to boost performance and competitiveness within their industry.

Industry tailoring allows each health, fitness, and wellness program to become part of the management structure of the target organization. The program therefore reaches 100% of the workforce. This is different from traditional programs who typically offer a range of health activities, such as health fairs, seminars and blood pressure checks, health assessments that are voluntary and therefore only attract workers who are interested.

In one embodiment injury prevention, personal health management, and recovery from injury (disability management) are combined within one, single program. This is due to a code of fitness that is called AlphaOne.

In one embodiment, each participant is assigned an AlphaOne Code of Fitness. It is the target of the entire workforce to achieve the AlphaOne Code of Fitness. AlphaOne achieves success by motivating and supporting high-risk employees to take action to lower their risk while, at the same time, supporting healthy workers to maintain their fitness. The Code of Fitness is confidential so the employer is not given any details about individual employees. However, the Code of Fitness allows an AlphaOne organizational profile to be prepared which shows the employer percentages of the workforce who have an A1 score (low risk) ranging through to a C3 score (high risk). This score enables a manager or another participant to make decisions regarding allocation of resources to address potential high risk, high cost elements of the workforce in a targeted and efficient manner.

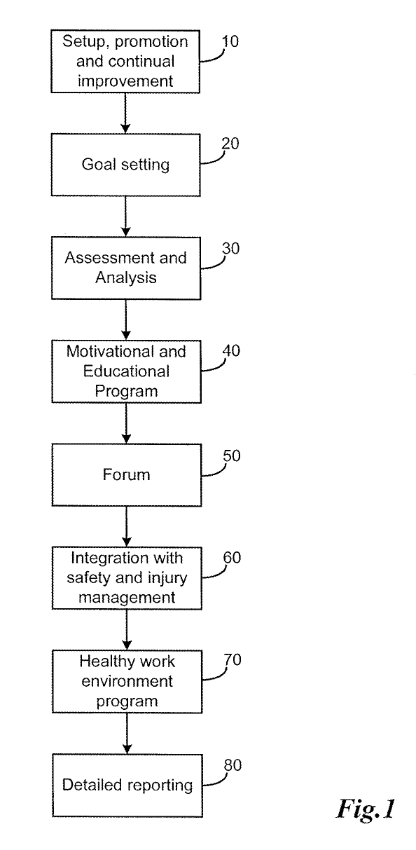

FIG. 1 shows a method of using a health, fitness, and wellness program. At box 10, the program is set-up in a workplace.

To achieve and sustain high participation rates and attract employees with high health risk, AlphaOne establishes: on-site support groups/steering committees involving key personnel in planning and follow-up. An invitation and/or encouragement from management and/or unions to employees. Promotion of the program including posters, intranet promotions, and articles in the company newsletter. Further supervisor/manager involvement is encouraged in promotion.

Support exists for the program at a senior management level. This, in one embodiment, includes the formation of a Steering Committee. The Steering Committee preferably will meet no less frequently than once every four months. The purpose of the Steering Committee is to keep senior management informed of the program progress; to involve senior management in planning and problem-solving; and to encourage senior management to use the program to achieve organizational objectives.

Support exists for the program within key work groups, preferably in work locations and/or divisions. This includes the formation of AlphaOne Task Groups at larger work locations and/or a nomination of Key Contacts with whom the AlphaOne program coordinator can liaise. For efficiency, Task Groups and Key Contacts are preferably pre-existing Safety Committees and/or Safety representatives.

At box 20, there is an individual, team and/or organizational goal setting session.

At box 30, there is a health needs assessment and a physical demands analysis (PDA) of a worksite. In one embodiment, there are three aims of this stage: to engage the workforce and build support for a health program; to understand historical and organizational issues to be addressed by the program; and to benchmark characteristics of the workplace and the workforce (e.g. organizational attitudes, health risk behaviors and physical and environmental attributes).

In order to achieve the foregoing aims, company injury and illness records are reviewed and semi-formal interviews are held with selected experienced and new personnel. Work locations are visited and digital images captured of physically demanding work practices. These locations are preferably identified by a Task Group and through interviews as being potentially problematic. The images and information gathered are incorporated into the AlphaOne training modules or health forums.

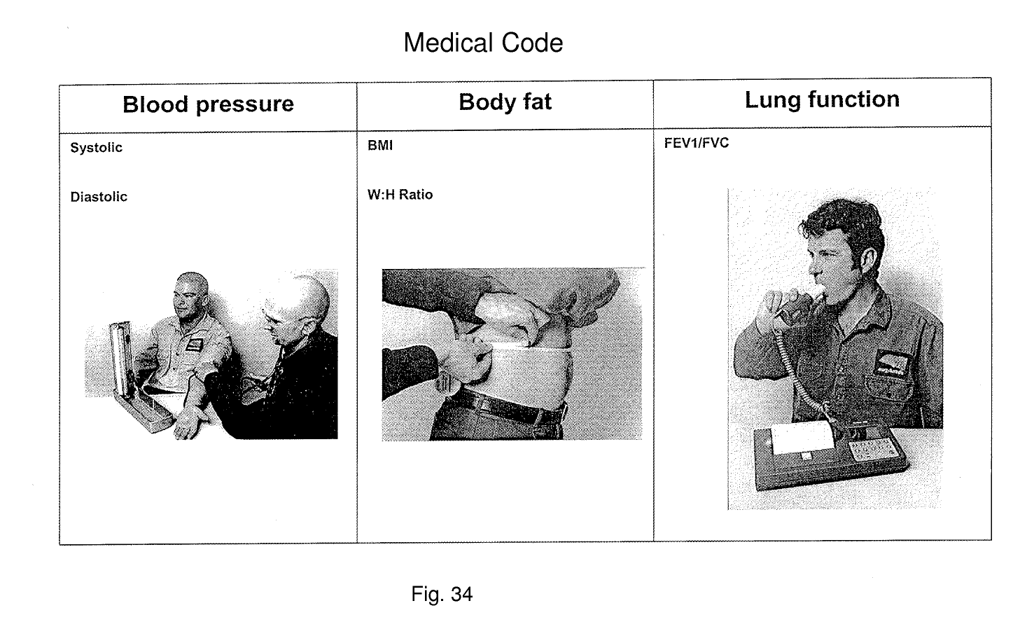

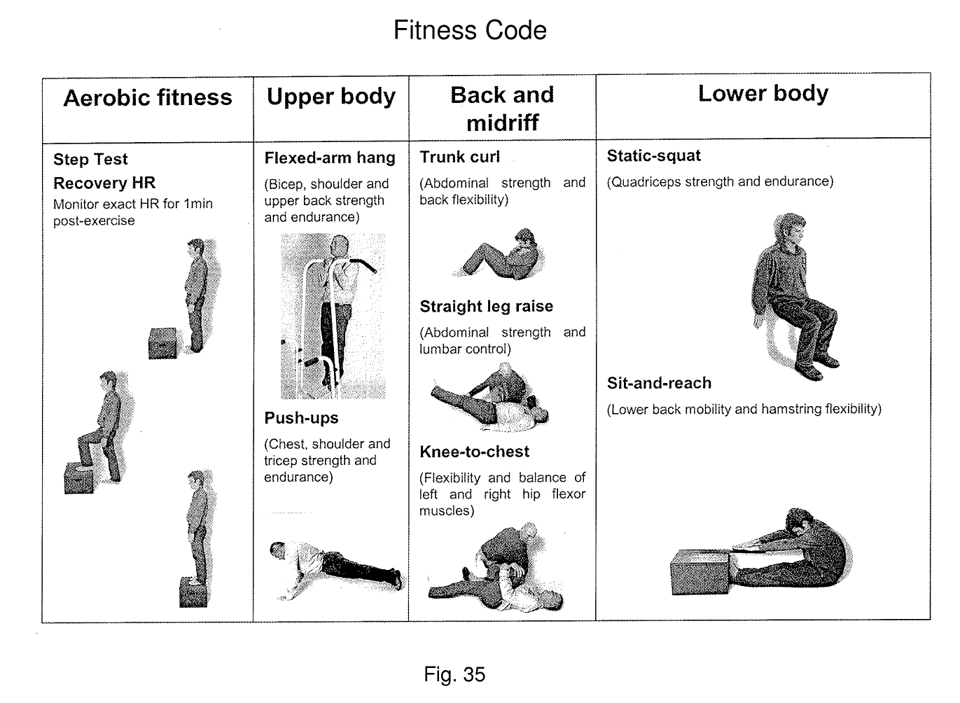

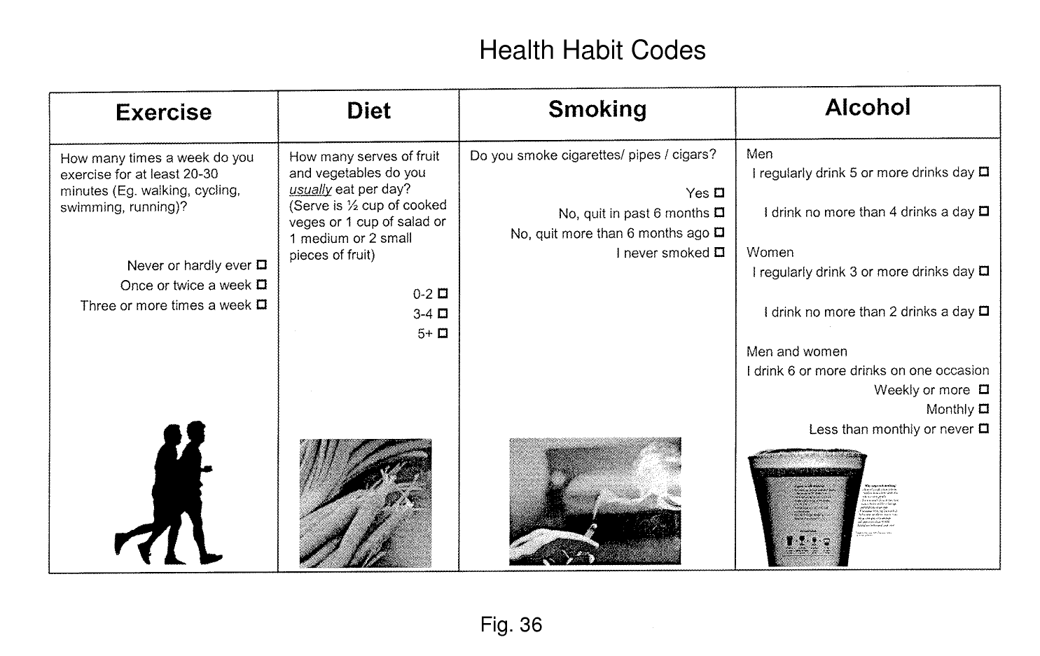

Health, safety and productivity data will enable AlphaOne to monitor and report indicators of program impact upon health care costs, productivity and return-on-investment. The table below indicates, in one embodiment the factors testes in the assessment. Also see FIGS. 34-36, which show screenshots of assessing the AlphaOne Code of Fitness in one embodiment.

| Medical | Fitness | Behavioural | Psychological |
|---|---|---|---|
| Profile | Profile | Profile | Profile |
| Medical | Aerobic Fitness | Exercise habits | Happiness and |
| History | Upper Body | Diet and eating | coping |
| Blood | Strength | habits | Sleep |
| Pressure | Back and Midriff | Smoking | Depression and |
| Body Mass | Strength, | Alcohol | sadness |
| Index | Mobility and | consumption | Social interaction and |
| Waist-Hip | Stability | including binge | support |
| Girth | Lower Body | drinking | Stress and anxiety |
| Lung | Strength and | | Pain management |
| Function | Mobility | | Job satisfaction and |
| | | | sense of control |

At box 40, there is a Health and Fitness Assessment. Personal Health

Programming takes place, providing users with a code of fitness that is both motivational and educational. In one embodiment, the health and fitness assessment preferably takes 60 minutes and includes one-to-one counseling, medical and employee assistance program (“EAP”) referral, health and fitness action plans and follow-up. Employees attending the AlphaOne health and fitness assessment receive confidential, one-to-one counseling. Employees who have risk factors for poor health and injury are referred to a doctor and strongly advised to attend follow-up health forums at which health messages given during counseling are reinforced and team members learn how to support each other in achieving their health goals. Employees who score highly on indicators of psychological distress are referred to a doctor of their choice and to the company's EAP as appropriate.

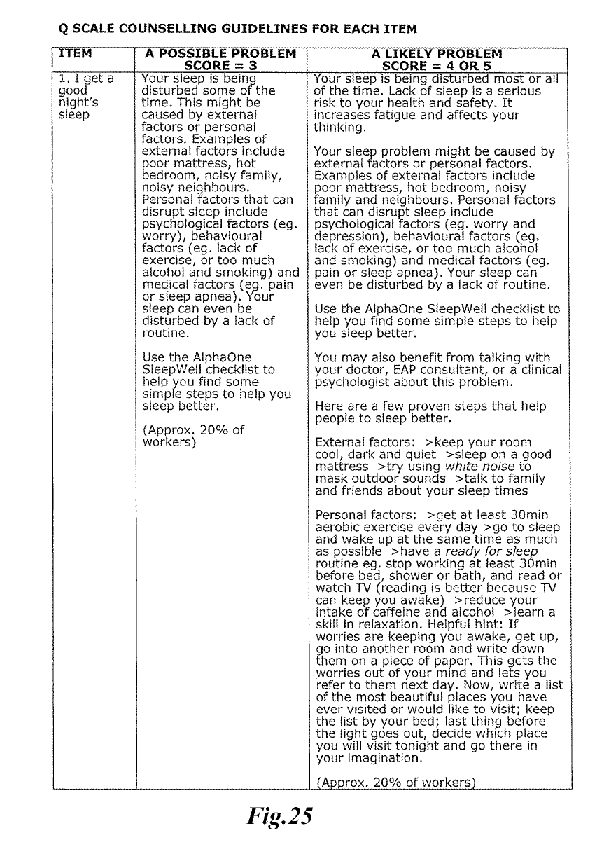

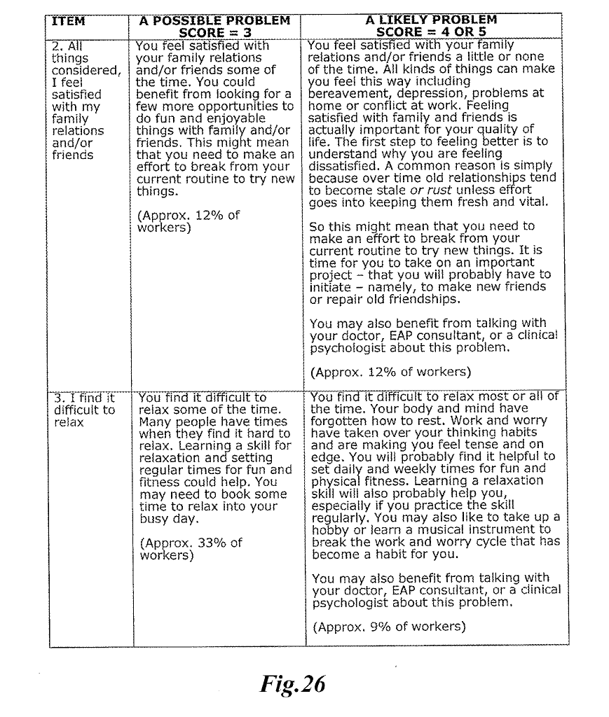

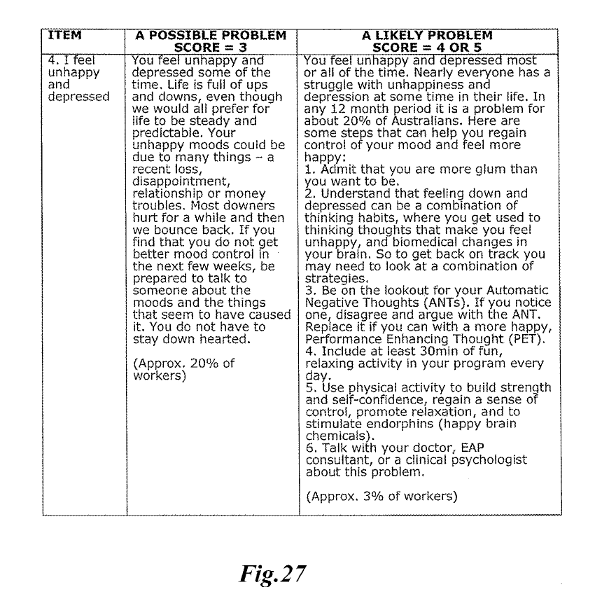

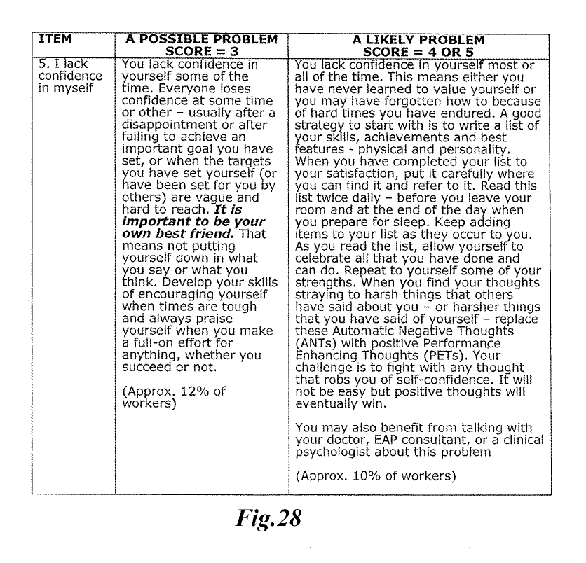

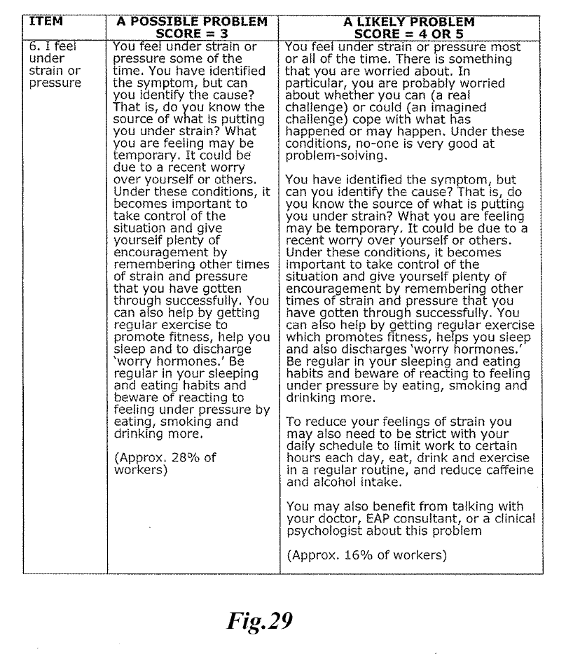

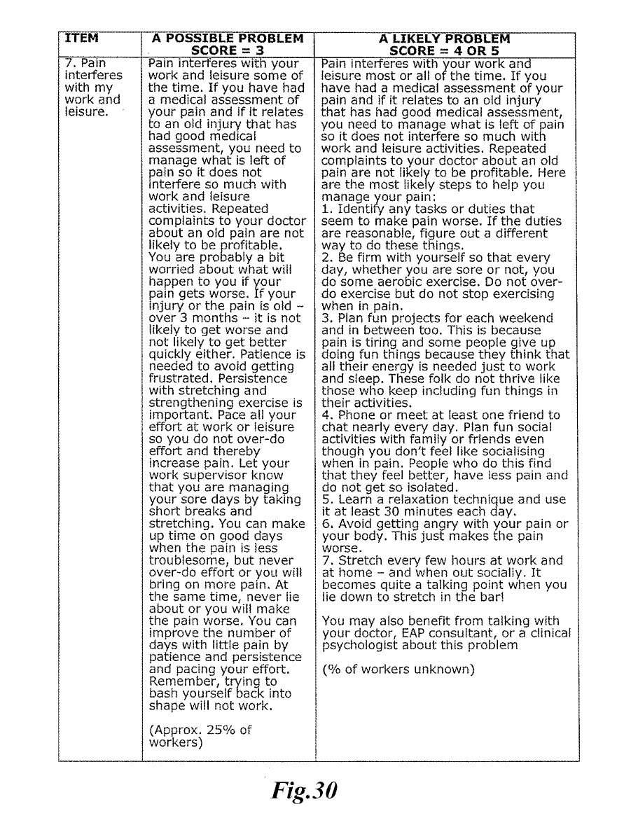

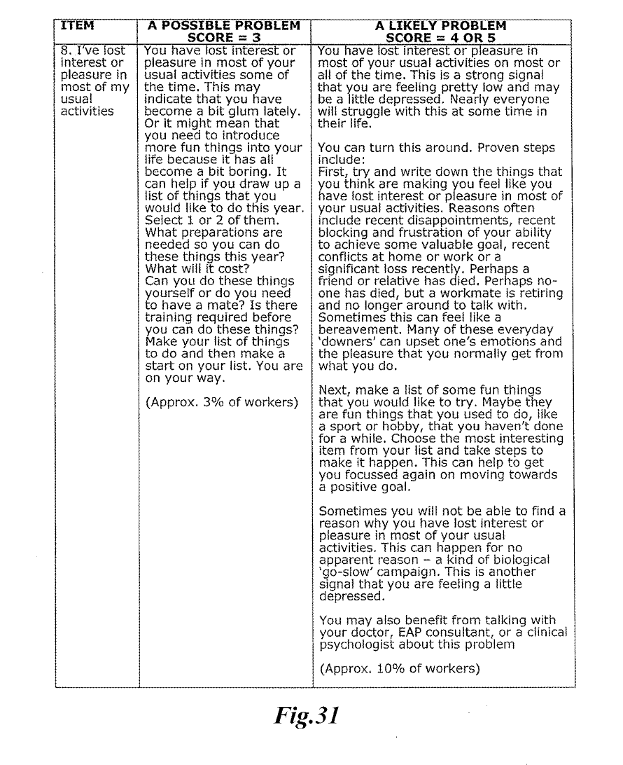

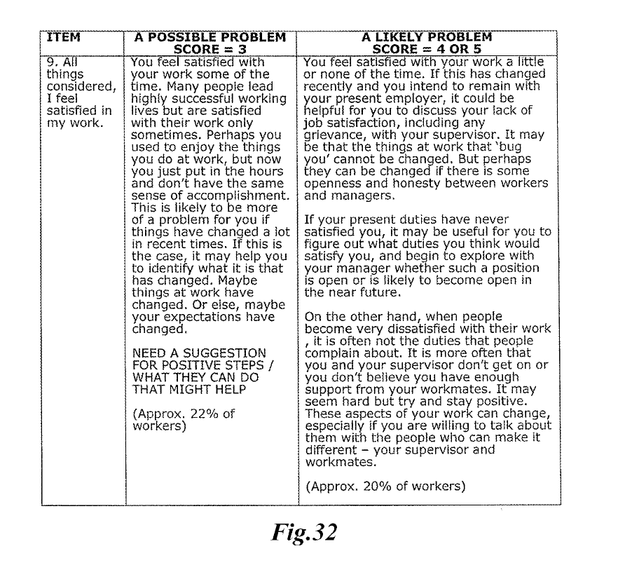

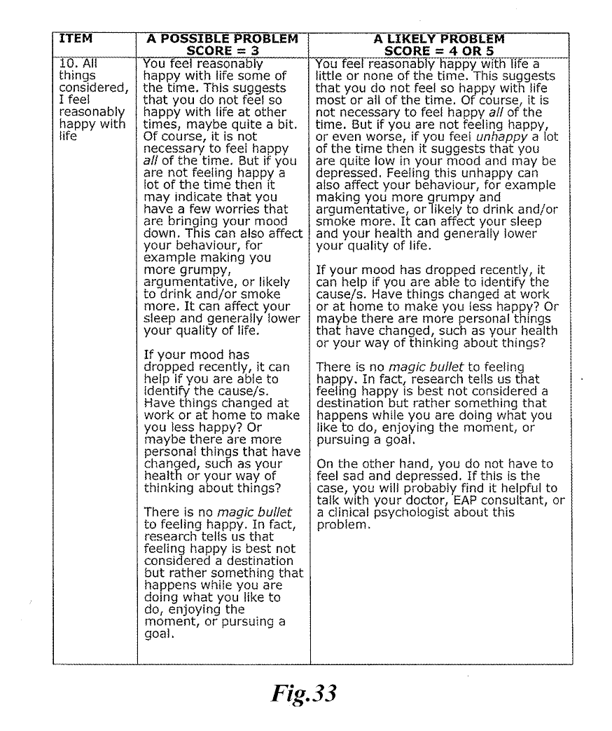

The health and fitness assessment includes, in one embodiment, targeted support programs for individuals at high risk on key measures of health and fitness. In one embodiment these programs include: the AlphaOne Q-Scale (see FIGS. 25-32) which is a validated instrument for detecting and counseling on a range of psychosocial and behavioral health issues such as sleep problems, pain, family and social problems, and mental health problems including mood disorders such as anxiety and depression. Unlike other commonly used instruments, known to those skilled in the art, such as the Kessler 10, GHQ, and the DAS, the Q-scale has been designed to raise employees' awareness of these conditions through questioning, as distinct from asking direct and disquieting questions about mental illness. The Q-scale has proven to be effective to encourage employees who are experiencing moderate to severe psychosocial problems, and whose health and safety are at risk, to talk about their problems with the counselor and to consult with their doctor and/or their employer's EAP.

The AlphaOne Love Handles CD is directed at overweight, obese and morbidly obese employees. The CD changes the way workers think about their weight, directing them towards taking the next step to weight management, in consultation with their doctor.

The AlphaOne Six Pack is a targeted intervention for employees found to be drinking at very hazardous levels. The Six Pack is a kit preferably comprising fun, informative and interactive educational resources that is given to employees who score ‘high risk’ on measures of alcohol consumption.

Further, in one embodiment, assessments includes the participant receiving their own high quality full color health and fitness assessment, personal fitness planner and information booklet to take away and use throughout the program and to compare results at the follow-up assessment.

This assessment differs from a basic health check because of the combination effect of the Code of Fitness and the time taken with the participant to explain their code. Some example questions would be: what the participant's health and fitness status means and preferably, what they can do about it to change, set goals and improve their overall health, fitness and quality of life.

It is the counseling and coaching components of the assessment which occur at this stage which take time and act as a critical intervention to help move people to real behavior change e.g. out of pre-contemplation and into contemplation or preparation. This is particularly the case with higher risk employees who invariably have a number of risk factors requiring focused information and coaching and often referrals to their general practitioner.

At box 50, there is a Health Forum series that is linked to the code of fitness and a PDA. The program is supported by a series of team training sessions called Health Forums. Health Forums focus on key OHS issues involving employees in the health management process. Health Forums increase workforce knowledge, understanding and skills in human movement, sleep management, healthy eating, problem-solving, and team work for safer, healthier work practices.

Health Forum topics include: The Health of OHS, which shows the links between personal and occupational risk factors. SmartMoves Parts 1 and 2, which includes understanding muscles, bones and joints; principles for safe, strong posture, movement and protecting the back. It further includes a re-conditioning program for the back; smarter, safer work practices; and personal fitness programming. EatWell, which includes food, nutrition and energy needs for work and lifetime changes to energy needs. It describes why bowel cancer is one of the biggest killers and how to prevent it; hydration, drugs and alcohol; a weight management program; and smart snacks. Beating the Worry Bug, which includes understanding mental health issues at work; the relationship between stress, anxiety and depression; cognitive behavioral therapy techniques and how to use positive self-talk; case studies using sports stars and well-known personalities; and finally learning a relaxation technique. SleepWell, which includes strategies for better sleep and less fatigue; relevant for all employees; includes checklists for sleep hygiene, sleep routine, and sleep environment. PainLess, which includes a session on what happens when you hurt; lack of movement and the vicious pain cycle; why back pain comes back; the healing process and how to help it; and inspiring stories from people managing their pain. The Body at Work, which includes occupational exposures and the most vulnerable body parts; how eyes work and eye protection; hearing loss—when is it too late?; airborne hazards and your lungs; and where does ‘cancer’ come from. The Psychology of Change which includes review links between personal health, happiness; state-of-the-science statistics; and the psychology of change—why we behave the way we do and how to change for good. SmartMoves Part 3 which includes, physical fitness; techniques to stabilize and protect your joints; hands-on practical instruction; focus on backs; and planning and fitness programming. This forum preferably gives you more advanced knowledge and skills about fitness, strong posture and movement. Simple skills are used to stabilize joints for greater strength and power and less aches and pain. SmartFood which includes healthy eating and your energy needs; metabolism, blood sugar and syndrome X; how to maintain healthy blood sugar and blood fat; and how to use the Glycaemic Index and why it could save your life. Fighting Fit, which includes a personal plan to boost your immune system; understanding the relationship between stress, anxiety and depression; knowing the difference between physical and mental relaxation; and why relaxation is preferable for health. This forum includes relaxation technique. In an alternate embodiment, these forums are a recording on an audio medium.

At box 60 integration with safety and injury management takes place. At box 70 a healthy work environment program takes place. At box 80 there is detailed reporting (written reports and presentation of data) to key stakeholders at all levels within the target organization based on milestones and agreed goals at program commencement.

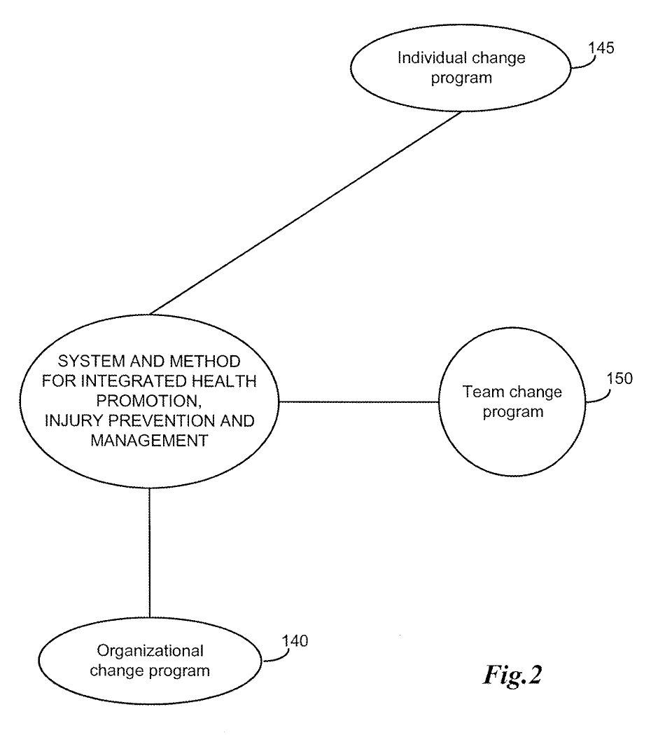

FIG. 2 shows the integration of the main themes of one embodiment. Box 145 represents and individual change program to reach all employees, including those at highest risk. Individual change strategies help employees to identify personal health risk facts, and motivate and support them to change and sustain habits for good health. Employees are given health messages and resources tailored to each individual's readiness to change given health messages and resources tailored to each individual's readiness to change. Box 150 represents a team change program, which is used to build communication and support with work teams. Box 140 represents an organizational change program to create a more supportive work environment to reinforce and sustain healthy change within the work force.

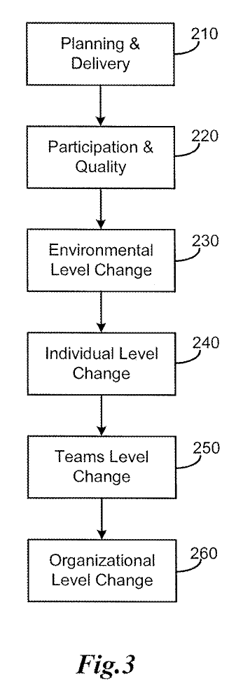

FIG. 3 shows a method of producing organizational level change. At box 210 is the planning and delivery of AlphaOne, this preferably includes successful planning and a successful launch. This area is measured by the task group. At box 220 is participation and quality by the participants. Work teams participate in the Alpha One program. This area is monitored by a survey. At box 230, there is an environmental change, resulting in a more health promoting work setting. This area is monitored by a checklist for health promoting environment at work. At box 240 there is an individual change. An individual participant has developed increased knowledge, improved attitudes and beliefs, safer work behaviors, in creased commitment to safety, adjusting to a healthy lifestyle, and improved fitness and health management. This area is measured by a survey, a health and fitness assessment, and the task group. At box 250 team levels change. A team has increased feelings of coworker and supervisor support; improved trust and communication; improved workplace relations; and improved attitudes toward the organization. This area is monitored by a survey and the task group. At box 260 there is organizational level change. As an organization there is improved productivity and satisfaction. There is reduced number of incidents. This area is monitored by company records and a survey.

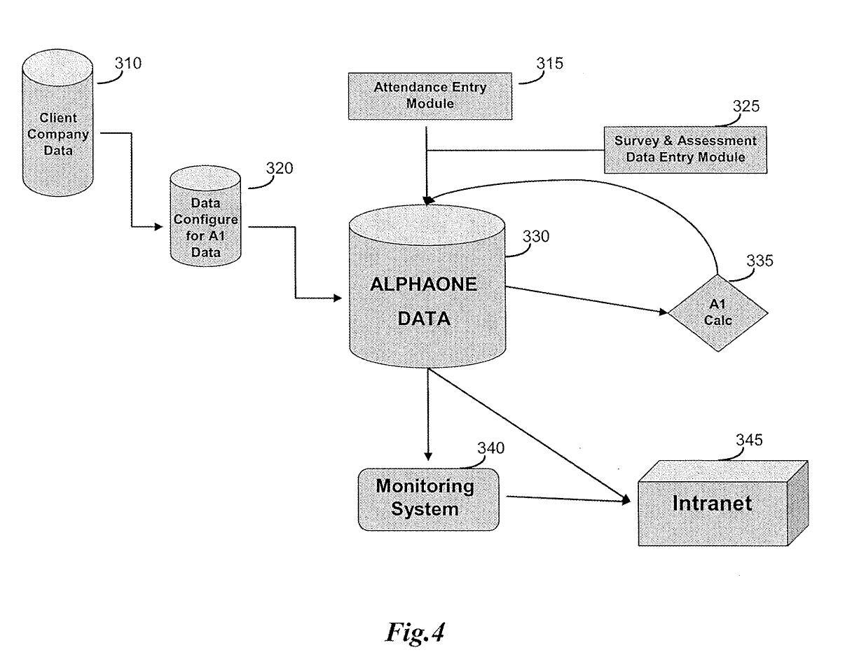

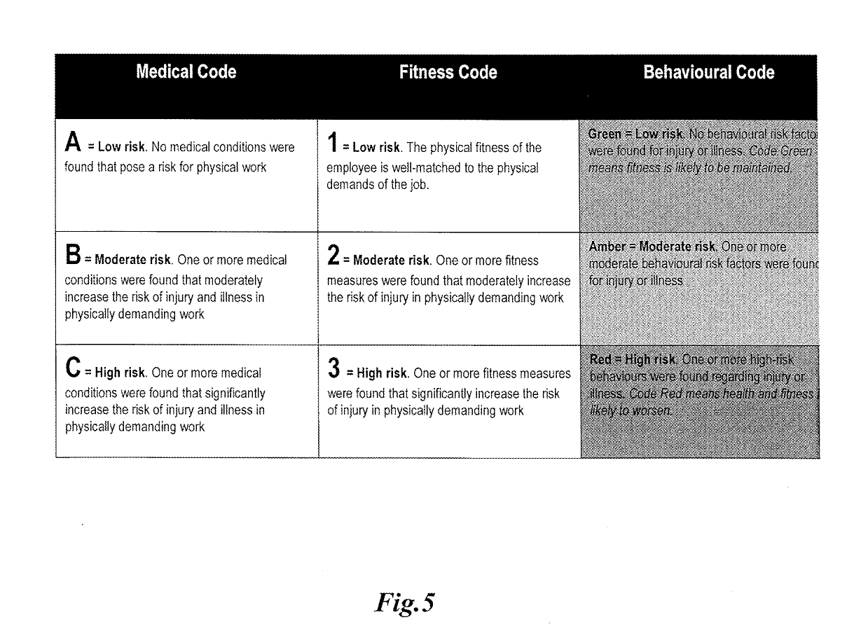

FIG. 4 shows a method of using a database. The database contains both an entry module for data documents and also a reporting function. At box 310 a set of data is gathered at the company in the set up phase. That data, at box 320, is then configured by a data manager to be entered into the database. At box 315 data is gathered from each participant as they are entered into the system. At box 325, surveys and assessments on each participant are incorporated with data from box 315. The data from the company and the participant data are then analyzed to produce an AlphaOne calculation, an example is shown in FIG. 5. At box 340 the data is monitored by a program coordinator, and can be accessed generally by an intranet.

FIG. 5 is a table representing the AlphaOne Code of Fitness.

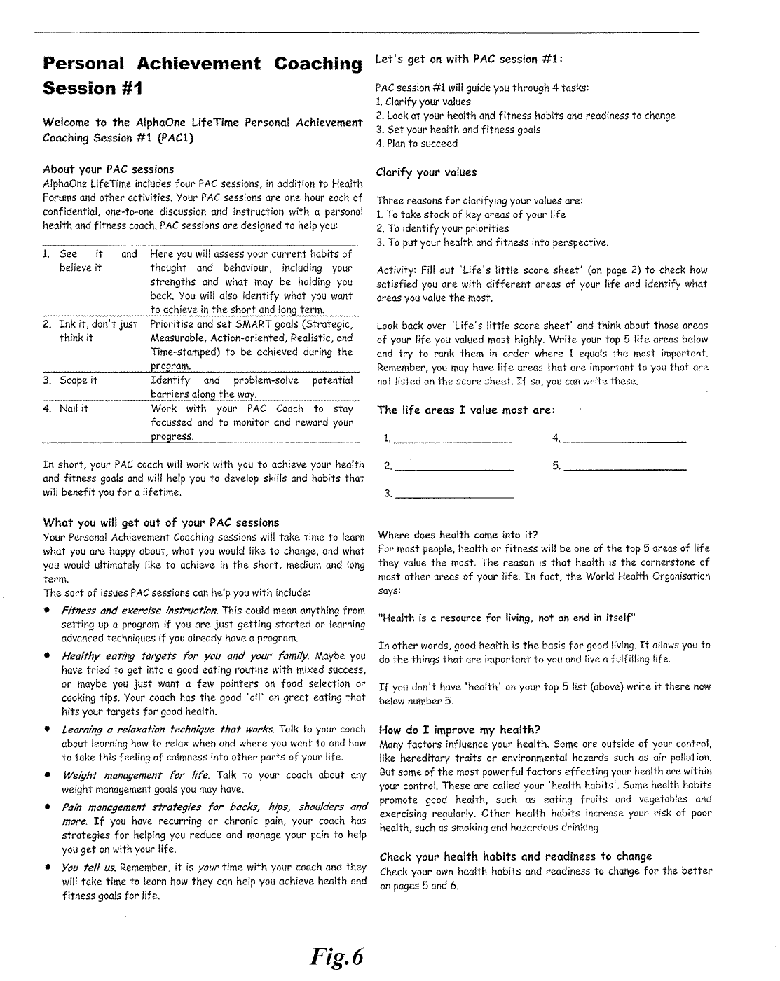

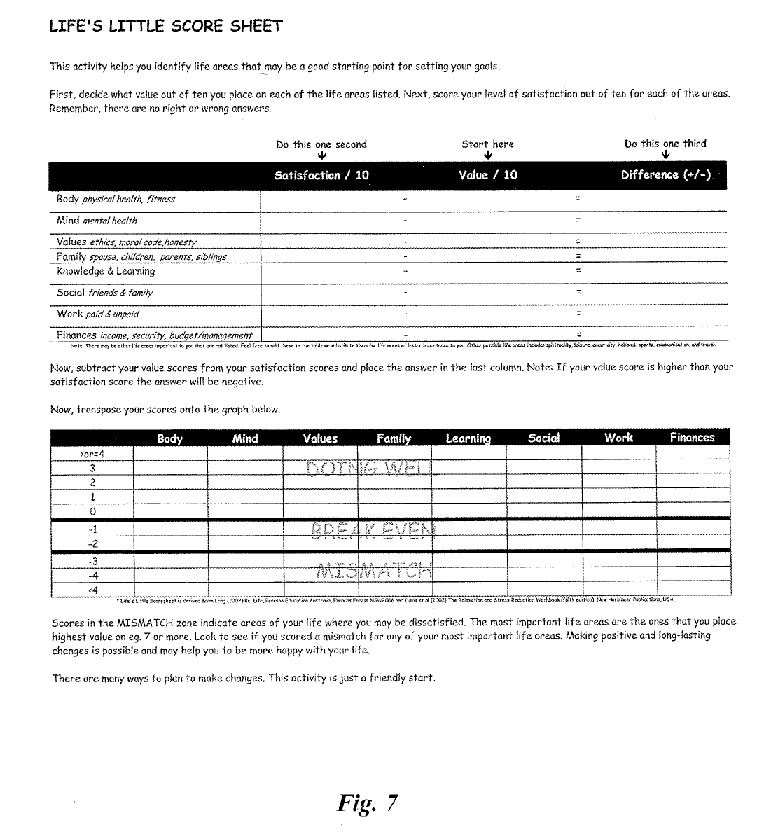

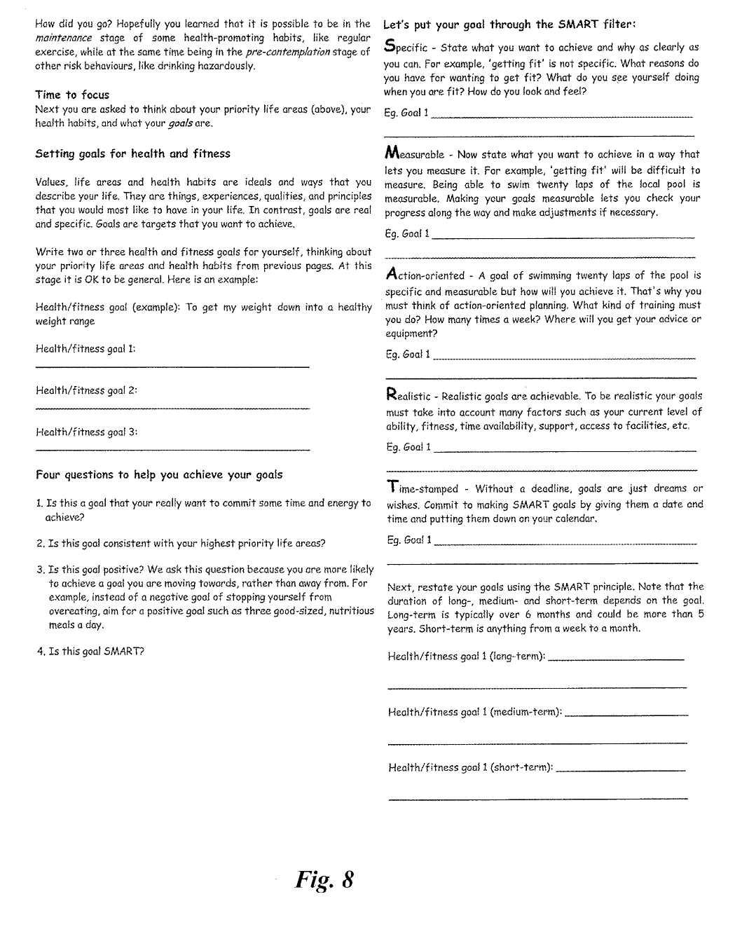

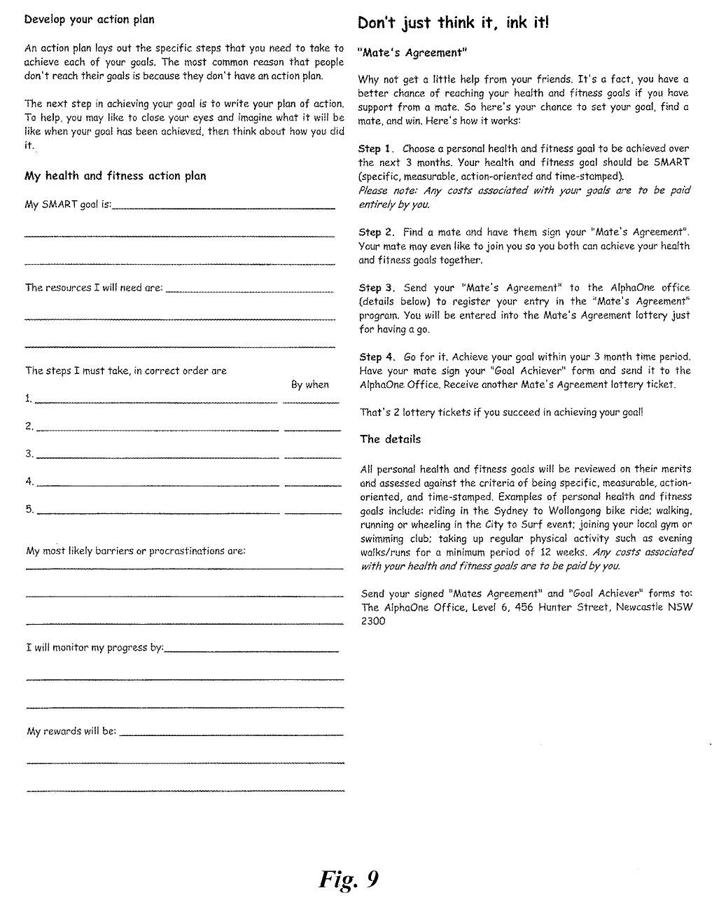

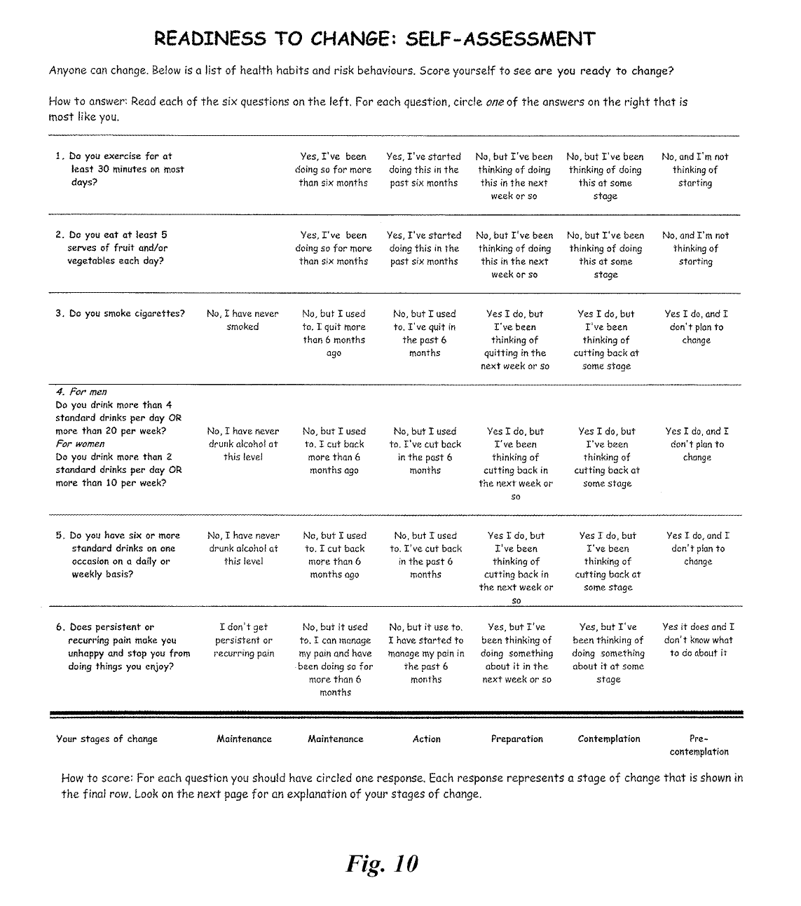

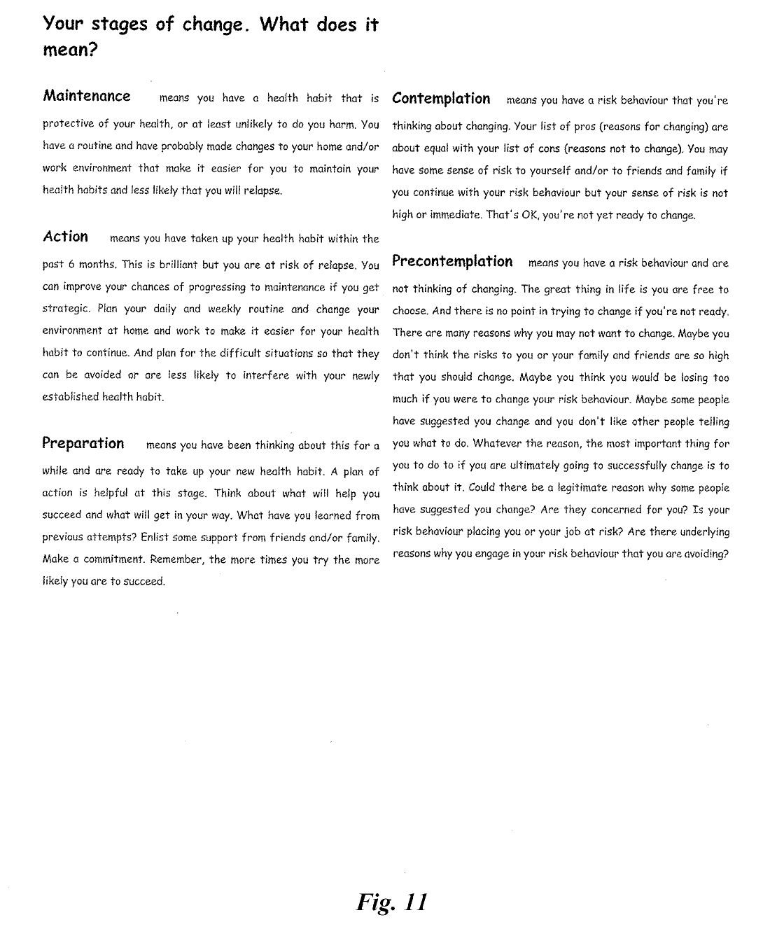

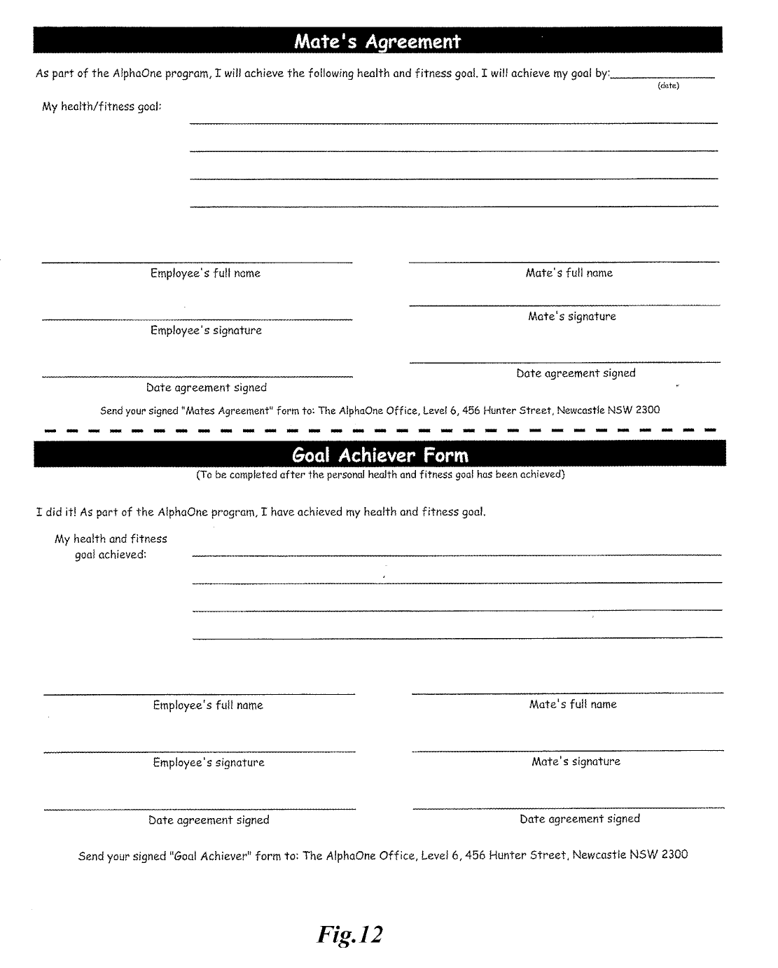

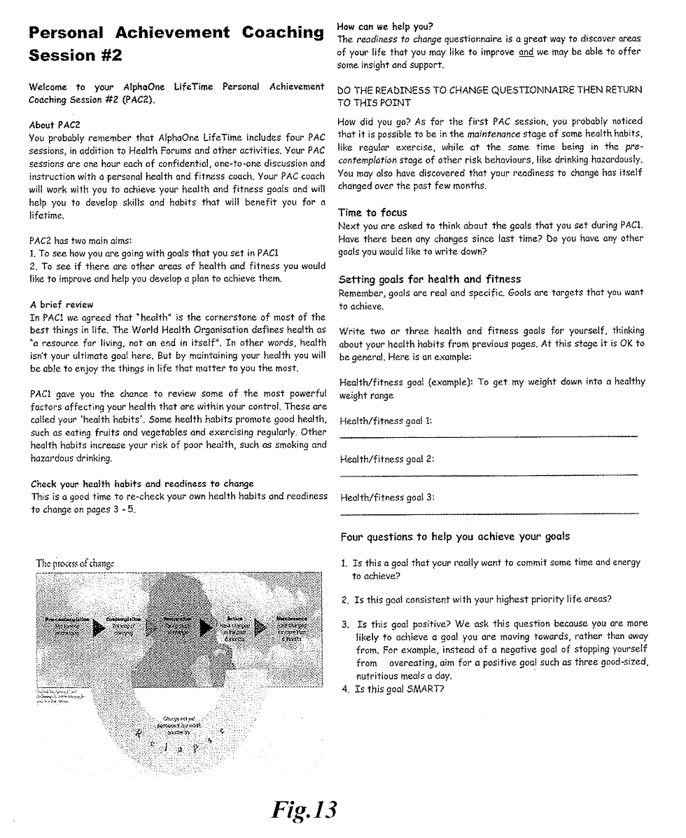

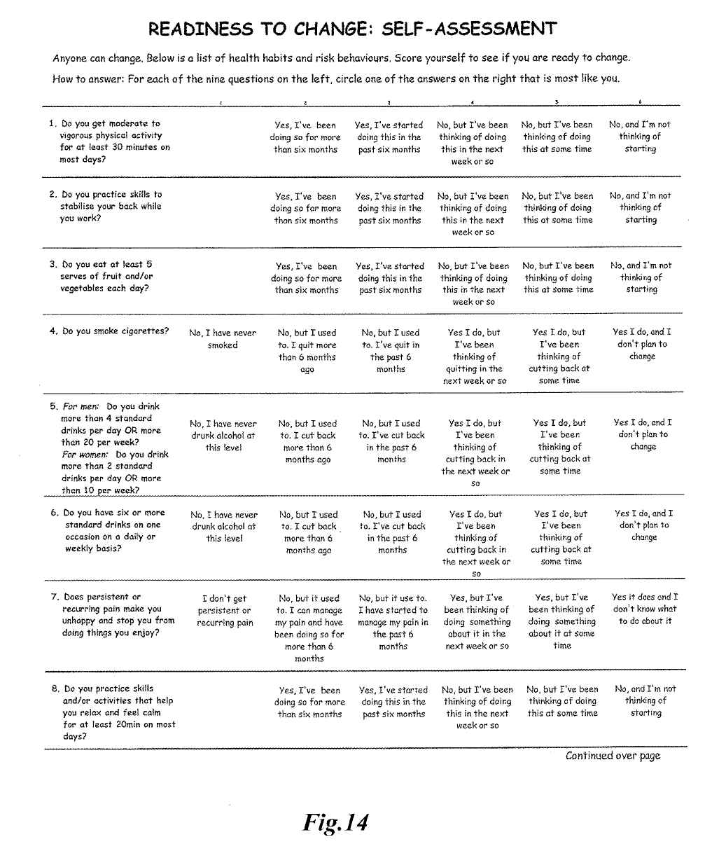

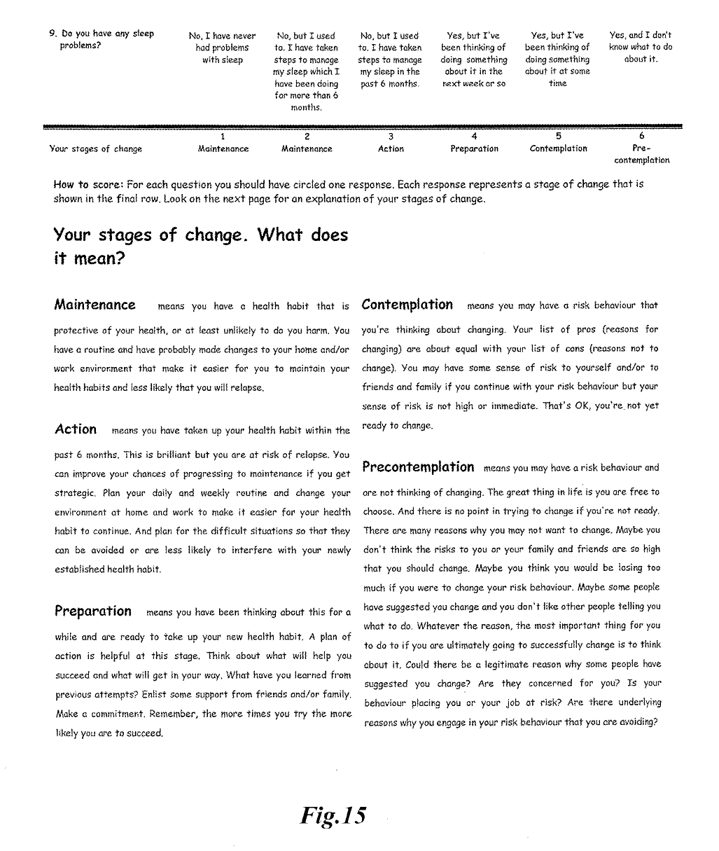

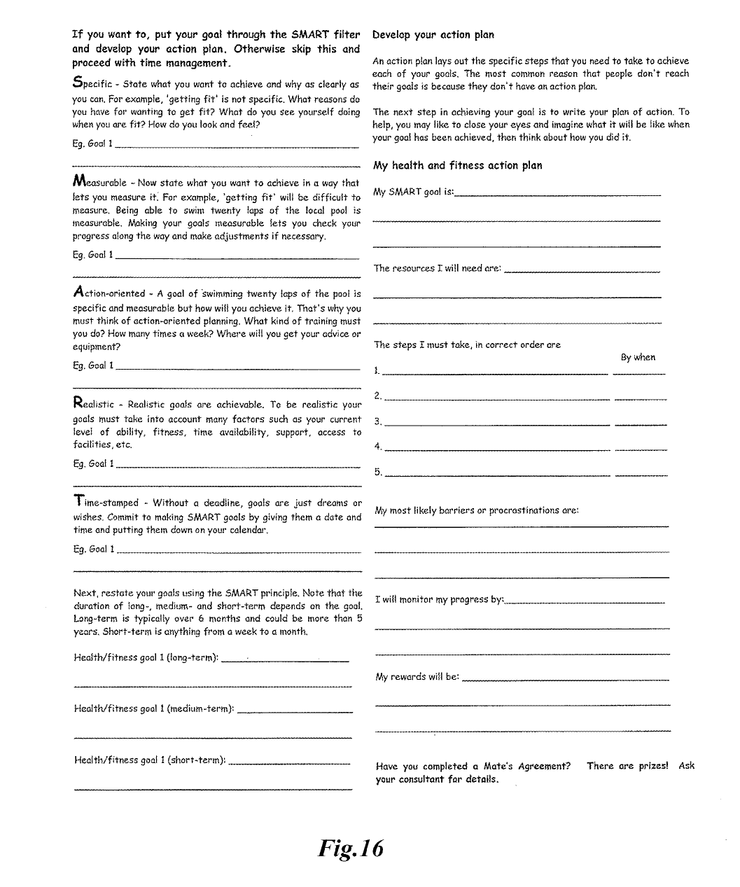

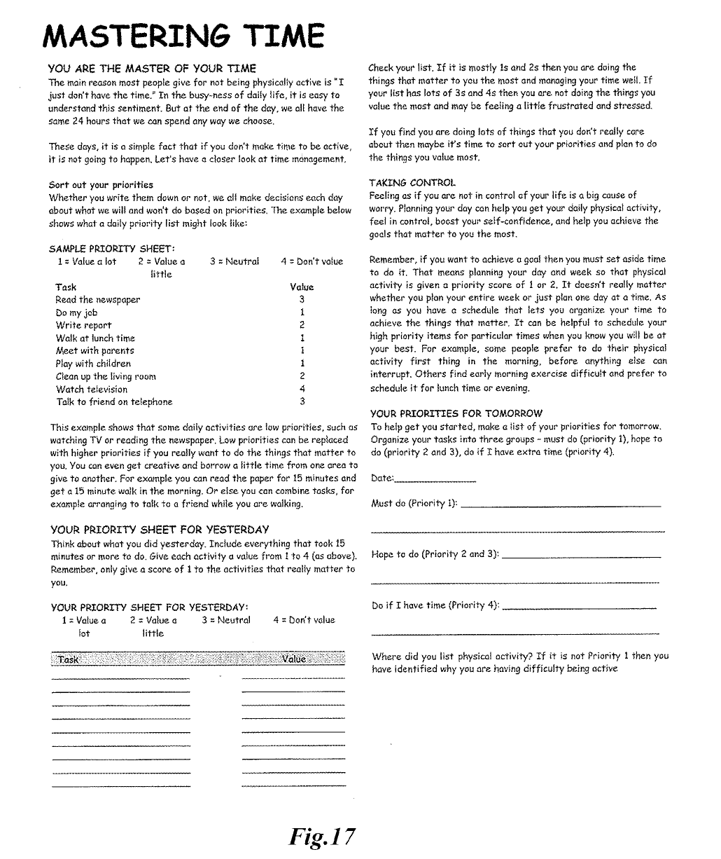

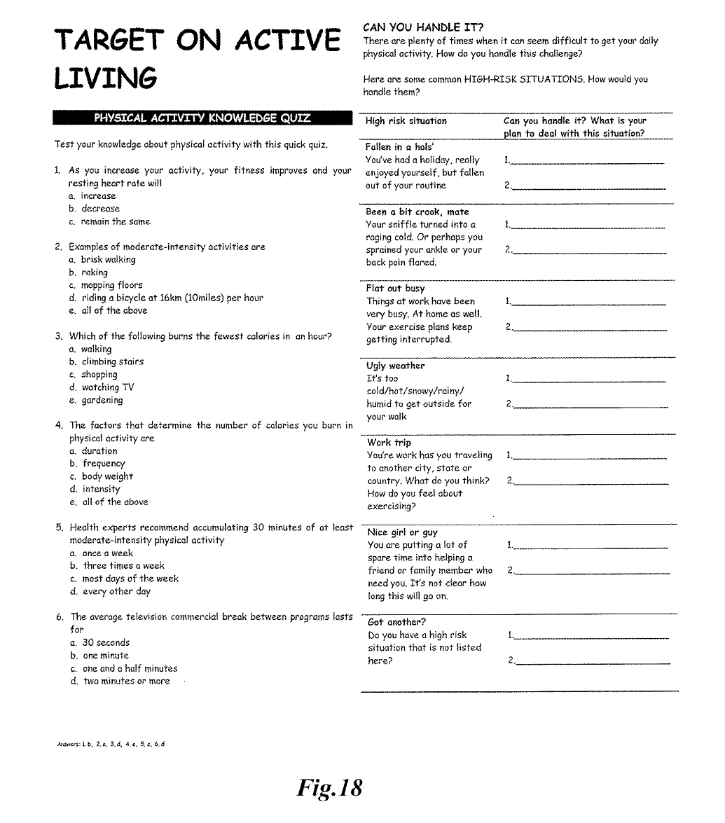

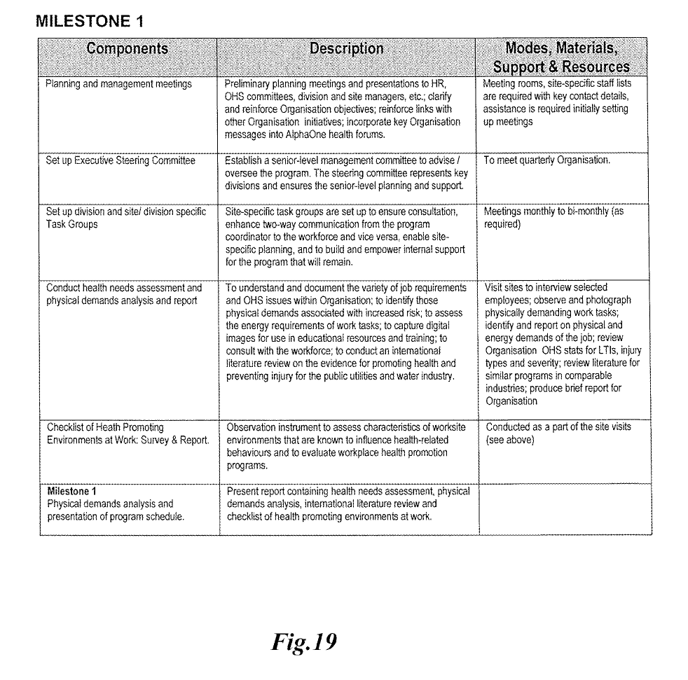

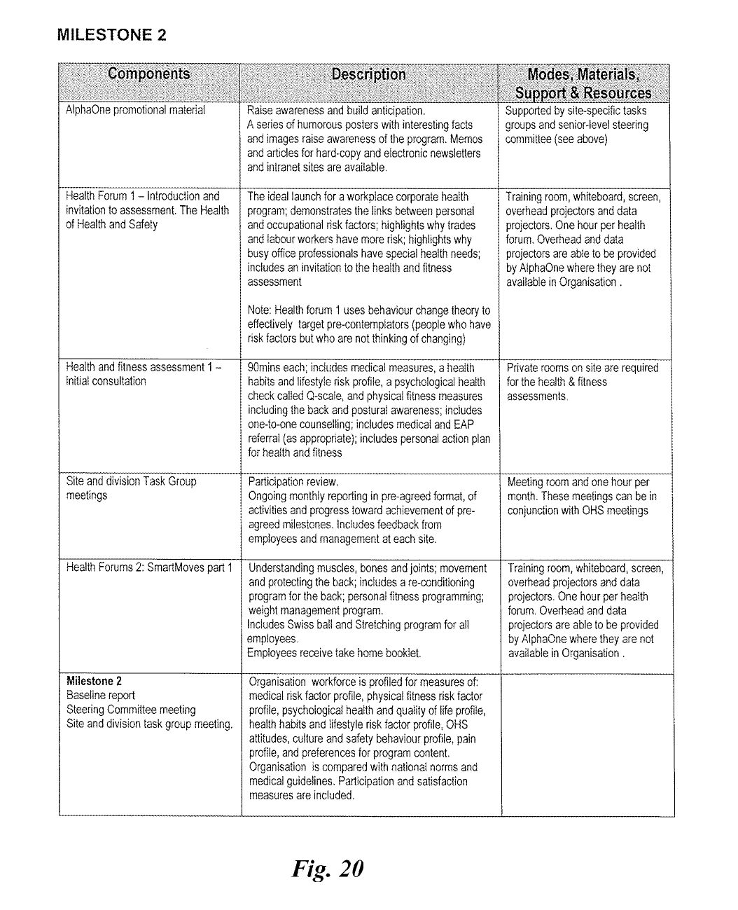

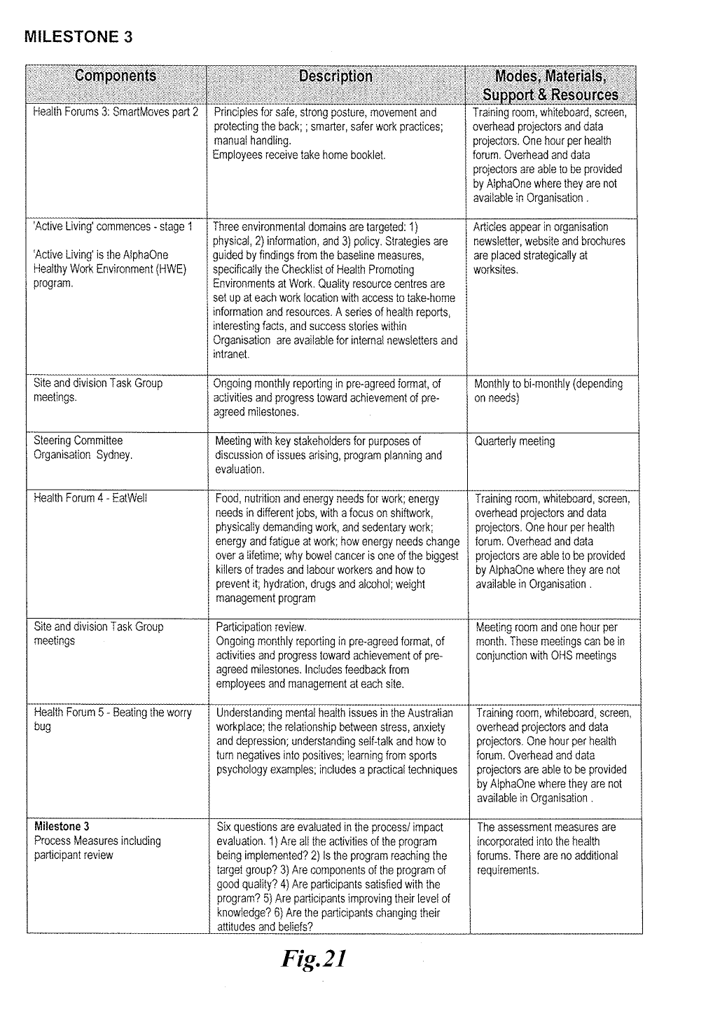

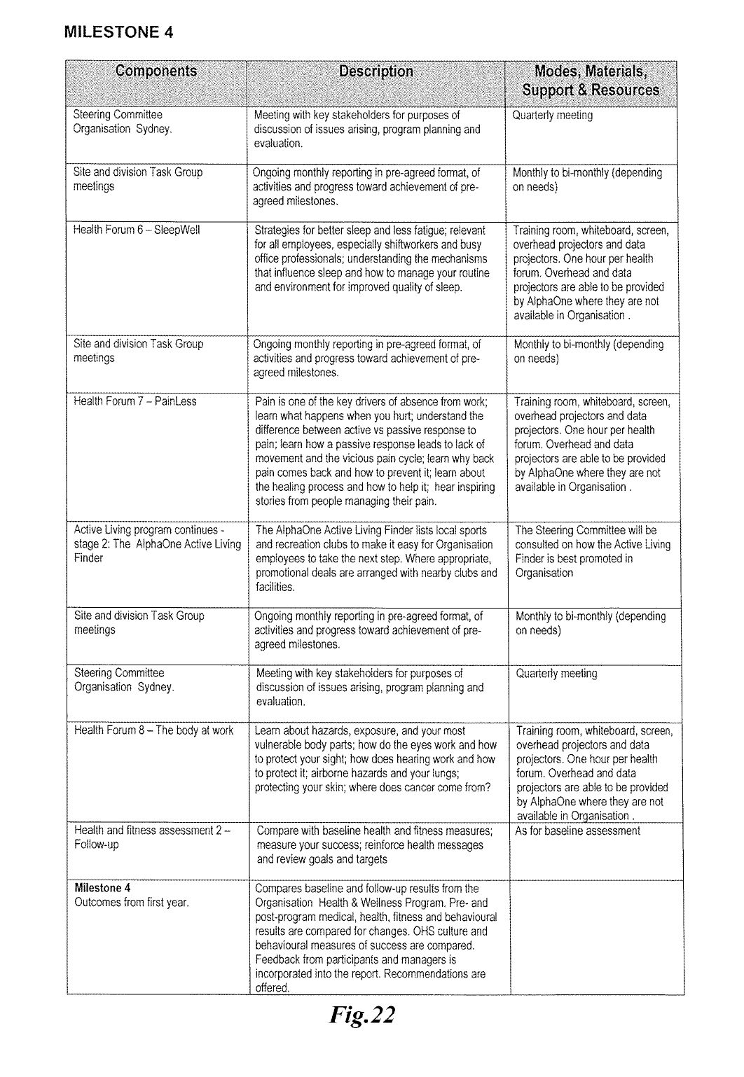

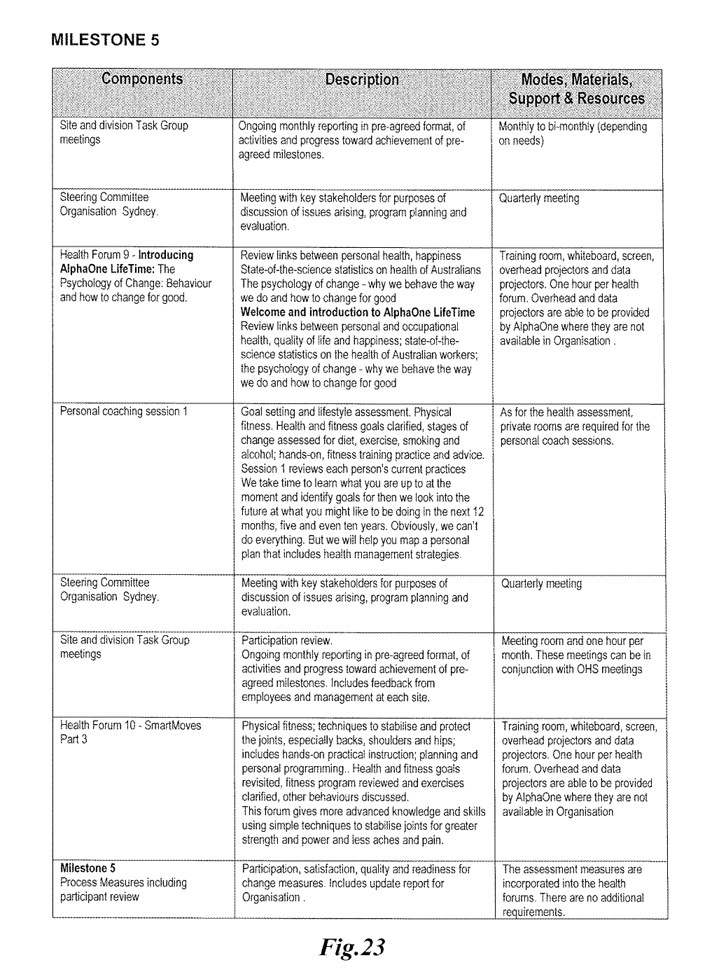

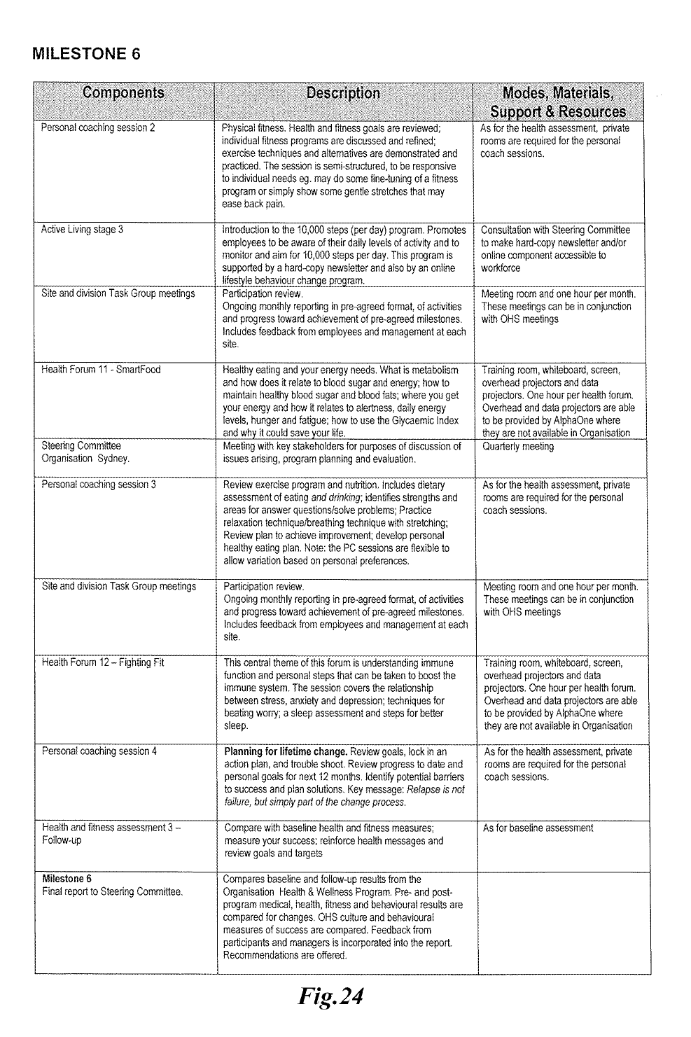

FIG. 6—are surveys used to determine a participants AlphaOne Code of Fitness.

In one embodiment, promoting employee and family health, fitness and quality of life fall under Environmental Program components and are a beneficial component of an integrated workplace health and fitness management program to achieve long term change and benefit to the organization. They are also preferable in as much as they offer the potential to further engage the workers through reaching their families and/or significant others.

In one embodiment, a Healthy Work Environment (HWE), the AlphaOne Resource Centre, which is a high profile on-site resource centre that is set up in strategic locations at each work place providing employees with access to state-of-the-science health information and take-home resources.

In one embodiment, AlphaOne has developed a self assessment which includes key components of the participant's baseline health & fitness assessment which participants can undertake in their home environment and self report into the AlphaOne™ database during the mid points of the Health and fitness program.

In one embodiment, as part of the AlphaOne program, geographic living regions of the workforce are reviewed and details compiled for another exclusive, research-based health resource developed by AlphaOne called the Active Living Finder. This includes all local recreation and fitness facilities, sports clubs, and contact details. The Active Living Finder supports employees who are thinking about taking the ‘next step’ to healthy change.

In one embodiment all components of the AlphaOne program are aligned with an effective incentive scheme for the integrated workplace health and fitness Management Program. It is a consequence of our advanced monitoring system that we are able to offer the AlphaOne Incentive Scheme (IS). The IS promotes participation and rewards employees who improve or maintain reasonable levels of health & fitness. Employees accumulate Incentive Points (IPs) when they attend program activities, achieve personal targets and when they improve or maintain their Code of Fitness.

In one embodiment, a total of 100 IPs can be earned. Employees who attain 50 IPs receive acknowledgement for a good effort. When employees attain 75 IPs, they are accepted into the ‘Hall of Champions’ and receive an award. Employees who attain 90 IPs are accepted into the ‘Hall of Legends’ and receive another award. Awards and Halls are acknowledged through newsletters and company communiqués and are also able to be viewed via the intranet. Incentive schemes work to further develop peer support and peer pressure and augment the behavior change process within specific teams and business units.

In one embodiment, the Mates Agreement is a structured personal goal setting program for participants. Each employee chooses a personal health and fitness goal/target to be achieved by the end of the program and finds a mate with whom they sign a ‘Mate's Agreement’. Preferably ‘Mate's Agreements’ are posted internally to the organizations key contact, or handed to one of the AlphaOne program coordinators. Employees are encouraged to ‘go for it’. If they achieve their target by the end of the program, they have their mate sign their ‘Target Achiever’ form and send it in. Mates Agreement targets are reviewed on their merits and assessed against the criteria of being specific, measurable, achievable, realistic and time-bound and must contribute to helping participants improve or maintain their AlphaOne Code of Fitness.

In one embodiment AlphaOne is able to report on: validated work productivity questions designed to calculate an employee's work performance that can be converted into a dollar value. Detailed reporting of the AlphaOne Code of Fitness including medical, fitness, and health. Health behaviors and psychosocial Q-scale. Monitoring linked to the AlphaOne database that reports on individual, team and organizational program participation. Participation rates reported against health and fitness outcomes to demonstrate the dose-response. Medical history; OHS attitudes and behaviors; AlphaOne Code of Fitness against age; AlphaOne Code of Fitness by job category; Divisional, business unit or team based reporting; Pain profile; Perception of health; AlphaOne Code of Fitness reported against absenteeism, incident and injury statistics; Physical Demands Analysis (PDA) based on site visits and literature review. The code of Fitness in relation to the PDA and job tasks that are high risk/high frequency and the levels of health and fitness that are recommended for the particular role; and productivity survey and reporting to report on organizational productivity and ROI.

In one embodiment, the workforce is profiled for measures of: medical risk factor profile, physical fitness risk factor profile, psychological health and quality of life profile, health habits and lifestyle risk factor profile, OHS attitudes, culture and safety behavior profile, pain profile, and preferences for program content. The organization is compared with national norms and medical guidelines. Participation and satisfaction measures are included. Presentations of program results are made to management as well as detailed written reports. The organization will receive a detailed executive level baseline presentation and a comprehensive written baseline report showing overall and regional outcomes for the program.

In one embodiment the organization has the option of a program being evaluated at the mid point of the health and fitness program. Preferably, six broad questions are evaluated in the process and/or impact evaluation. 1) Are all the activities of the program being implemented? 2) Is the program reaching the target group? 3) Are components of the program of good quality? 4) Are participants satisfied with the program? 5) Are participants improving their level of knowledge? 6) Are the participants changing their attitudes and beliefs?

In one embodiment, a follow-up report compares baseline and follow-up results from the Integrated Workplace Health & Fitness Management Program. Pre- and post-program medical, health, fitness and behavioral results are compared for changes. OHS culture and behavioral measures of success are compared, Cost-Benefits are reported. Feedback from participants and managers is incorporated into the report. Recommendations are offered.

Further with confidentiality maintained the Code of Fitness becomes the unique identifier for such reporting and provides valuable baseline and trending data to the organization for reporting ROI and cost/benefit analysis at the baseline, during the program and in the long term follow up.

In one embodiment program evaluation will begin with reviewing progress on all measures taken in the Health and Fitness Assessments. This measures changes to the collective workforce's fitness and medical condition. Health and fitness assessments provide detailed measures of risk factors and also changes to the ‘Code of Fitness’ profile of the workforce and the matched participants. Participation in any or all of the program components with points and rewards attached as deemed by the organizations health and fitness program steering committee. Measuring changes to the collective workforce's attitudes, knowledge and behaviors using a comprehensive survey. Measuring changes to the organizations absenteeism, lost time injuries and workers compensation records against participant's health changes using a highly sophisticated organization productivity index.

In one embodiment, the integrated workplace health & fitness program will be measured. The framework shows that the project will be evaluated at strategic points to provide the organizations with feedback on meaningful areas of impact and outcomes. This will occur for health and fitness assessment delivery, participation and quality, positive changes to the health and fitness of employees, feedback from work teams, and positive change indicators for the organization.

In one example embodiment a grip test is used to determine upper body strength. Upper body strength is a preferable fitness attribute for stabilizing and protecting joints of the neck and shoulders. Office work often requires some degree of upper body strength for tasks such as handling boxes and files, moving office furniture reaching for high files or objects. Key areas of upper body fitness include strength and endurance of grip (wrist and forearm), biceps, shoulder girdle muscles, and muscles of the upper back and chest. The grip test has been shown to be a valid measure of muscular strength that has been shown to have a high correlation with traditional strength measures of chest press and elbow flexion strength (r=0.672) and may even give an approximation of total body muscle strength. Handgrip strength has also been associated with a decline in ageing population's functional ability, a decline in decreased fat free muscle mass and used as a possible diagnostic tool for work related upper limb injuries.

The equipment used is a hand grip dynamometer; Jamar Hydraulic hand grip dynamometer; BTE-Primus grip tool; Rolyan hydraulic dynamometer; Smedley Handgrip dynamometer; and TTM hand grip dynamometer.

Either the participant or the assessor may stop the test at any time if adverse symptoms or undue stress are apparent. The assessor must always be attentive for signs of distress in the participant.

In one embodiment the procedures are to ensure the dynamometer is set to zero. Adjust the dynamometer to fit the participant's hand. The space is to be equal to space between the inside of the participants thumb and the second knuckle. Record whether the participant is either left or right handed. If unsure the writing hand is to be recorded as the dominant hand. The subject is to stand with the heels, buttocks and back resting against a wall. Re-check that the dynamometer is set to zero. The subject is to grip the dynamometer in the dominant hand and hold it vertically above the head. When ready, ask the subject to grip as hard as possible while moving the arm through a 180′ arc (in the anteroposterior plane) to the count of three. The arm must remain locked, straight at the elbow, throughout the grip maneuver. Take the dynamometer from the subject, read the score to the nearest 0.5 kg, and record it on the data sheet. Measure the grip of the non-dominant hand, read the score and record. Repeat the procedure twice for both hands recording the maximum score for each hand. Calculate the average of both left and right hands.

The grip test measures strength specifically for the forearm flexors. It can also provide an indication of over all upper body strength. Good strength in the upper body is preferable for tasks such as lifting or carrying objects. The grip test can also be a good indicator of how your total upper body strength is traveling. Good upper body strength in the biceps, shoulder girdle muscles and muscles of the upper back and chest are preferable for stabilizing your shoulders and protecting us against injury during physically demanding work. This can include moving office furniture, moving boxes or large stacks of files as well as the activities we perform at home and outside work such as house work, renovations or gardening and even playing with or tending to our children. Due to the fact that we perform work with our upper body our hands and wrists will also be used. This means that if your general upper body strength is good then usually your grip strength will also be good. Therefore grip strength can be used to assess the strength of your grip and as an indicator of your overall upper body strength. Grip strength has also been used to identify risk of injury to the upper body for people who do physical work. A decline in grip strength has been associated with a decline in muscle mass and a person's functional ability.

Male norms for grip strength (average of left and right hand)

| | Age (years) | | | | |
|---|---|---|---|---|---|
| Rating | 18-29 | 30-39 | 40-49 | 50-59 | 60-69 |
| Poor | <=42.50 | <=45.90 | <=44.30 | <=42.50 | <=37.40 |
| Fair | 42.51-50.30 | 45.91-50.80 | 44.31-49.00 | 42.51-46.50 | 37.41-41.00 |
| Good | 50.31-56.00 | 50.81-56.50 | 49.01-55.00 | 46.51-51.00 | 41.01-45.50 |
| Excellent | >56.00 | >56.50 | >55.00 | >51.00 | >45.50 |

Female norms for grip strength (average of left and right hand)

| | Age (years) | | | | |
|---|---|---|---|---|---|
| Rating | 18-29 | 30-19 | 40-49 | 50-59 | 60-69 |
| Poor | <=28.50 | <=28.00 | <=27.00 | <=24.50 | <=22.80 |
| Fair | 28.51-30.30 | 28.01-31.00 | 27.01-30.00 | 24.51-29.00 | 22.81-25.00 |
| Good | 30.31-34.00 | 31.01-34.50 | 30.01-33.00 | 29.01-32.00 | 25.01-28.00 |
| Excellent | >34.00 | >34.50 | >33.00 | >32.00 | >28.00 |

The grip test measures strength specifically for the forearm flexors. It can also provide an indication of over all upper body strength. Good strength in the upper body is preferable for tasks such as lifting or carrying objects. The grip test can also be a good indicator of how your total upper body strength is traveling, however it isn't specific enough for us on it's own for to show us how your over all upper body strength.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for health promotion comprising:
integrating participant risk information;
assessing health needs of the participant;
assigning a code of fitness to the participant; and
developing a fitness action plan.
